(19) United States
(12) Patent Application Publication
(10) Pub. No.: US 2023/0320255 A1
(43) Pub. Date: Oct. 12, 2023

(54) COVER CROPPING DEVICE AND METHOD

(71) Applicants: Robert Alan West, Vulcan (CA); Brett James Robertson, Vulcan (CA)

(72) Inventors: Robert Alan West, Vulcan (CA); Brett James Robertson, Vulcan (CA)

(21) Appl. No.: 18/131,277

(22) Filed: Apr. 5, 2023

Related U.S. Application Data
(60) Provisional application No. 63/328,380, filed on Apr. 7, 2022.

(51) Int. Cl. A01C 7/06; A01C 23/00; A01C 23/04

(52) U.S. Cl. CPC A01C 7/06; A01C 23/008; A01C 23/047

(57) ABSTRACT

A convertible sprayer and seeder is provided, including a liquids tank; one or more liquid discharge lines leading from the liquids tank to one or more nozzles, said nozzles being arranged along booms extending from the sprayer; a seed metering applicator; one or more seed lines, each connected from the seed metering applicator to each of said one or more liquid discharge lines; a venturi located at each connection between each seed line and each liquid discharge line; a spraying bypass mechanism associated with each of said one or more liquid discharge lines; and a seeding valve associated with each connection between the one or more seed lines and the one or more liquid discharge lines. When the seeding valve is closed the bypass mechanism allows spraying and when the seeding valve is opened, the bypass mechanism allows seeding. A method of seeding a cover or relay crop is also provided.

### FIELD

The present disclosure relates to a device and method for cover cropping or for relay cropping.

### BACKGROUND

In agriculture and farming, it is unheard of to produce a crop without supplying it with all the nutrients that it needs to grow throughout the season. In particular, the addition of nitrogen is crucial to plant and crop growth. During winter and fall, the land is often allowed to sit idle with nothing growing on it. Yet, research has found that if something is growing on the land for as many days as possible, this can help to promote nitrogen availability and bioactivity below the surface which aids in improving soil health.

The concept of a relay or cover crop, and regenerative agriculture can help improve soil health. This happens through the planting of a second crop between rows of a primary crop. In cover cropping, the second crop is not harvested or used as a further crop product. In relay cropping, the second crop is harvested as well. In both cases, the goal is to make nitrogen available and create a digestible root system to aid in soil health.

In the interest of environmental health, governments have also set goals for the reduction of synthetic fertilizers used in agriculture. As such, it is more important to provide an underground farm ecosystem with living rooting to provide shelter and food for the soil biology.

In some parts of the world “double cropping” is possible, where a fast-growing crop is sewn after the first crop has been harvested. However double cropping is not possible in northern climates with short growing seasons.

Overwintering relay crops are planted in northern climates. Seeding of these relay crops occurs after harvest of the primary crop. Young plants germinate, survive winter, and continue growing in the spring.

In one prior art method, relay crop or cover crop can be established by using polymer coatings on the cover or relay crop seed to allow the farmer to seed both the main and relay/cover crop at the same time. The polymer coating on the seed, would delay the emergence of the relay crop or the cover crop. However, it has been found that the polymers vary in thickness, and do not allow an adequate time frame for the main crop to grow up and before the cover/relay seeds are exposed and begin growing.

Other methods include the use of a helicopter to seed the second crop over the primary crop. However, seed loss from wind and inaccurate seed placement lead to poor plant stands.

DE10205917A1 teaches a modified transport device for combined spraying and seeding comprising a vehicle or trailer carrying a liquid fertilizer tank (1) fitted with a seed container a line leading from the seed container to a main suction line upstream of a spraying pump.

U.S. Ser. No. 10/528,048B2 teaches an autonomous vehicle platform configured to perform various in-season management tasks between the planted rows of an agricultural field, including seeding cover crops.

CN110741779A teaches a water and fertilizer integrated seeder and seeding method which comprises a walking device, a water spray device, a seeding device, a fertilizer discharging device, a seed and fertilizer mixing device, and an automatic seeding control system. However, due to differences in specific gravity of seeds and liquid fertilizer, even with mixing it is impossible to prevent either floating or settling of the seeds relative to the liquid fertilizer, leading to uneven distribution and clogging.

A need therefore exists for devices and equipment to sow cover or relay crops into an existing primary crop canopy that ensures even spreading, maximizes seeding and does not damage the existing crops.

### SUMMARY

A convertible sprayer and seeder is provided, including a liquids tank; one or more liquid discharge lines leading from the liquids tank to one or more nozzles, said nozzles being arranged along booms extending from the sprayer; a seed metering applicator; one or more seed lines, each connected from the seed metering applicator to each of said one or more liquid discharge lines; a venturi located at each connection between each seed line and each liquid discharge line; a spraying bypass mechanism associated with each of said one or more liquid discharge lines; and a seeding valve associated with each connection between the one or more seed lines and the one or more liquid discharge lines. When the seeding valve is closed the bypass mechanism allows spraying and when the seeding valve is opened, the bypass mechanism allows seeding.

A method of seeding a cover crop or relay crop is also provided. The method includes the steps of providing the convertible sprayer and seeder described above; opening each of the seeding valves and closing each of the bypass mechanisms; adjusting each nozzle opening to allow passage of seeds therethrough; and as the convertible sprayer and seeder is driven across a field, metering seeds from the applicator through the seed lines and through the venturi into the liquid discharge lines and out through the nozzles.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is side elevation view of one embodiment of a tank section of a modified sprayer of the present disclosure, as towed by a tractor;

FIG. 2 is a detailed plan view of a first embodiment of a venturi and valving arrangement of the modified sprayer of FIG. 1;

FIG. 3 is a rear elevation view of the modified sprayer of FIG. 1, showing the sprayer booms;

FIG. 4 is a side perspective view of a sprayer that can be modified by the present disclosure, in a boom contracted position; and

FIG. 5 is a top plan view of a second embodiment of a venturi and valving arrangement of a modified sprayer.

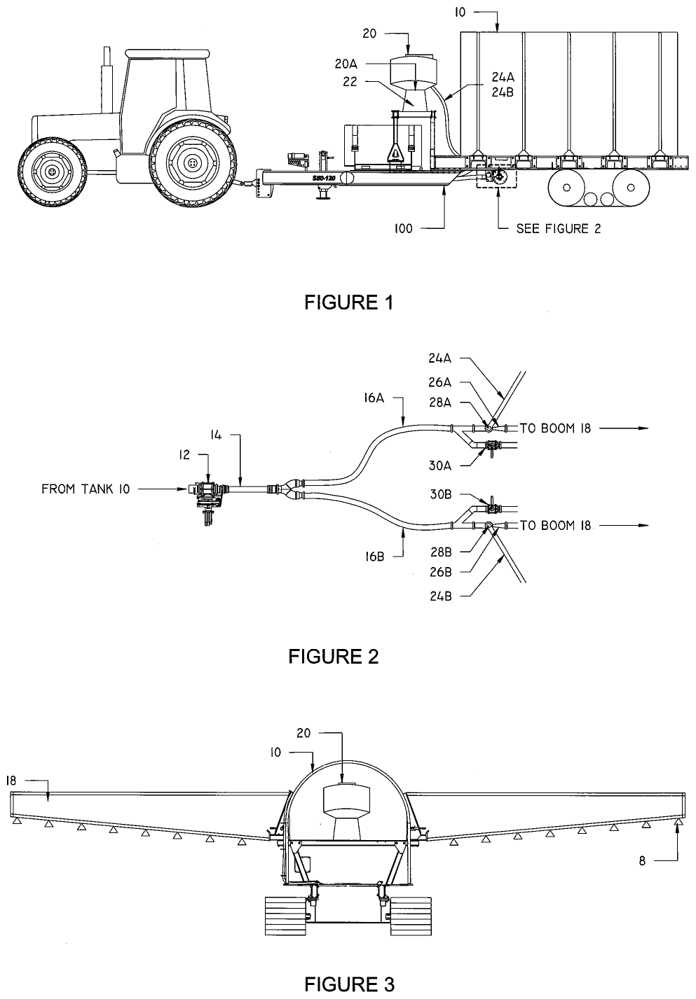

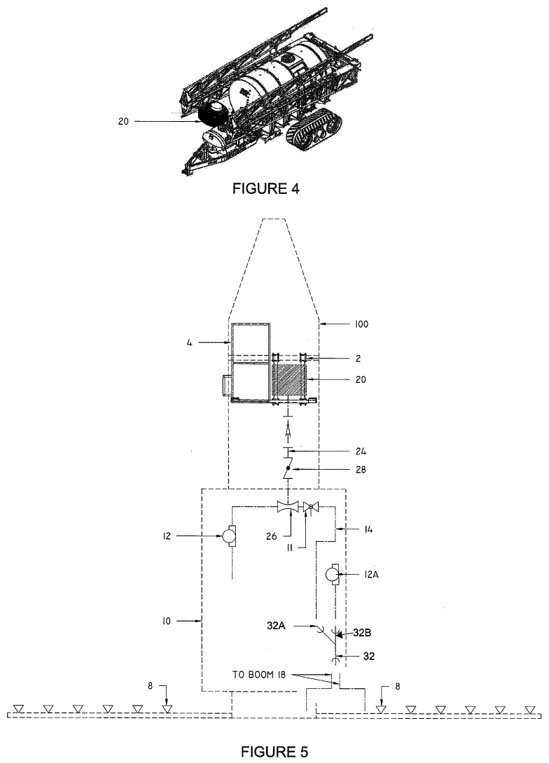

The drawings are not necessarily to scale and in some instances proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure relates to a device and process for cover or relay cropping into an existing main crop canopy. The present devices takes the form of a modified agricultural sprayer such that relay or cover crops can be seeded concurrently with standard spraying procedures.

Farmers use sprayers to apply pesticides and fertilizer to existing crops. The two most common types of sprayers are pull-type, pulled by a tractor, and self-propelled. With reference to the Figures, the modified sprayer 100 of the present disclosure comprises a granular applicator 20 with a metering device 20a that is mounted, preferably in front of a liquids tank 10 of the sprayer 100. The granular application 20 contains the seeds for relay or cover cropping, that are metered out at a rate set by setting the metering device 20a. Preferably, as illustrated in the embodiment of FIG. 5, a support frame 2 and support platform 4 are mounted to the sprayer 100 upon which the granular applicator can be mounted and supported in turn.

The liquids tank 10 can hold water, but more commonly holds a fertilizer, pesticide, or a combination of the two. The product mixed with water in the liquids tank 10 is determined by the requirements of the main crop, which will vary.

With reference to FIG. 2, in a first embodiment, a pump 12, pumps liquid from the tank 10 to a main liquid line 14, which then splits into two liquid discharge lines 16a, 16b, located on either side of the sprayer 100. Two seed lines 24a, 24b run from the granular applicator 20, to each of liquid discharge lines 16a, 16b.

Venturi inductors 26a, 26b are installed on each of the liquid discharge lines 16a, 16b to connect the seed lines 24a, 24b to the liquid discharge lines 16a, 16b on each side of the sprayer 100. Seeds are proportioned into the seed lines 24a, 24b from the granular applicator and are pulled into the venturi inductors 26a, 26b and deposited into the liquid discharge lines 16a, 16b and immersed in liquid, be it water, or fertilizer solutions. The immersed seeds enter liquid discharge lines 16a, 16b on each side of the sprayer 100 and are carried to the wet boom 18 and deposited into the ground along with the liquid material, through the spray nozzles 8.

The volume of liquid pumped by pump 12 is set to match the seed application rate, to prevent plugging of the nozzles 8.

The venturi inductors 26a, 26b serve to interrupt the liquid discharge lines 16a, 16b and provide a port to inject seeds into the spray stream. From the venturi inductor 26a, 26b the seed travels directly into the liquid spray stream of the wet boom 18 of the sprayer.

In the arrangement of FIG. 2, venturi inductors 26a, 26b are provided on each of the liquid discharge lines 16a and 16b to provide some independence to seed and liquid material flow to each side of the wet boom 18.

In an alternate embodiment, illustrated in FIG. 5, a single venturi inductor 26 is located on a single liquid line 14. In this embodiment a single seed line 24 feeds into the venturi inductor 26. As above, seeds are proportioned into the seed line 24 from the applicator 20 and are pulled into the venturi inductor 26 and deposited into liquid discharge line 14, which then forms branch 32A of the system, eventually joining up with other lines into main discharge line 32 that then supplies nozzles 8 on each side of the wet boom 18.

In this arrangement, an additional pump 12a also draws directly from the liquids tank 10 and feeds liquid 32B to main discharge line 32 that again supplies nozzles 8 on each side of the wet boom 18. The presence of secondary pump 12a ensure sufficient draw of liquids to induct the seeds into the line 32.

In the arrangement of FIG. 5, additional pumping and location of the inductor 26 on a non-branched line help to avoid back flow of liquid material into the seed applicator 20 should back pressure build up on the nozzles 8.

Both embodiments serve to avoid issues with seeds separating from the liquid, as can happen if seeds are added directly to the liquids tank 10, where there is a tendency for seeds to either float or sink. When the seeds exit the sprayer 100 through spray nozzles 8, they are surrounded by droplets of liquid. The liquid droplet that houses the seed allows for more efficient and successful planting of the cover or relay crop because the seed covered by the heavier liquid drop tends to better penetrate the canopy of the existing main crop, leading to improved soil-to-seed contact and higher likelihood of the cover or relay seeds germinating and growing. Less cover/relay crop seed is lost to wind, leading to a better plant per square foot ratio than experienced in the past.

The modified sprayer 100 as provided in the present disclosure allows even seed distribution across existing crop, since the boom 18 and nozzles 8 of the sprayer 100 are already arranged for even liquids distribution.

The applicator 20 is preferably equipped with a control panel 22, providing operators with the ability for infield calibration of seed metering, and adjust the seed application rate.

The present modified sprayer 100 is further equipped to switch from standard spraying operation to the present seeding device and back again, with very little time or effort.

In the embodiment of FIG. 2, seeding valves 28a, 28b are located on each venturi inductor line and can be turned open to allow flow of seeds into the liquid discharge lines 16a, 16b for seeding operation mode, or can be closed when the sprayer is operating only in spray mode. Seeding valves 28a, 28b are preferably ball valves. Bypass valves 30a, 30b are located on a bypass line around the venturi inductor 26a, 26b, and can be opened when seeding valves 28a, 28b are closed, to allow for spraying only operation mode. Alternatively, bypass valves 30a, 30b can be closed while seeding valves 28a, 28b are opened to allow seeds to enter the venturi inductor 26a, 26b for seeding operation.

In the embodiment of FIG. 5, a valve 28 can be closed to allow for spraying only operation mode, when seeding is not required. In this case, liquid material in liquid line 14 is still passed through venturi inductor 26, but with no seed added to the line. Check valve 11 serves to prevent backflow of seeds or liquids into the venturi inductor 26 or further back upstream, when the seeding device is not in use.

The present nozzles 8 on the booms 18 of the present modified sprayer 100 are preferably multi-headed nozzles. If nozzle opening size requires changing to switch from spraying to seeding operation, or to accommodate different seed sizes for seeding operations, then the multi-headed nozzles 8 can each be twisted to a different opening, along the boom 18. More preferably the nozzles 8 of the modified sprayer 100 are a flood jet type of nozzle, having a large throat opening to allow seeds to pass through and provide an even application or distribution of seed.

Seeds planted by the present cover cropping method will germinate under the existing canopy and will build mainly a root mass, taking every little nutrients and water as they are sheltered from sunlight because of the canopy. When this process is happening the plants of the cover/relay crop build nitrogen in the soil, trigger a nodulation process, and provide nitrogen to the existing crop.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A convertible sprayer and seeder, comprising:
a. a liquids tank;
b. one or more liquid discharge lines leading from the liquids tank to one or more nozzles, said nozzles being arranged along booms extending from the sprayer;
c. a seed metering applicator;
d. one or more seed lines, each connected from the seed metering applicator to each of said one or more liquid discharge lines;
e. a venturi located at each connection between each seed line and each liquid discharge line;
f. a spraying bypass mechanism associated with each of said one or more liquid discharge lines; and
g. a seeding valve associated with each connection between the one or more seed lines and the one or more liquid discharge lines,
wherein when the seeding valve is closed the bypass mechanism allows spraying and when the seeding valve is opened, the bypass mechanism allows seeding.

2. The convertible sprayer and seeder of claim 1, wherein the granular applicator serves to proportion seeds into the seed lines and wherein the venturi inductors serve to draw in the seeds and deposit the seeds into the liquid discharge lines to immerse seed in liquid.

3. The convertible sprayer and seeder of claim 2, wherein the immersed seeds enter the liquid discharge lines and are deposited into the ground along with the liquid, through the spray nozzles.

4. The convertible sprayer and seeder of claim 3, wherein the liquid is selected from the group consisting of water and fertilizer solutions.

5. The convertible sprayer and seeder of claim 4, further comprising a pump for pumping liquid from the liquids tank to each venturi.

6. The convertible sprayer and seeder of claim 5, wherein a volume of liquid pumped by the pump set in proportion to a seed application rate to prevent plugging of the nozzles.

7. The convertible sprayer and seeder of claim 1, wherein seed metering applicator comprises a control panel for infield calibration of seed metering and seed application rate.

8. The convertible sprayer and seeder of claim 1, wherein the one or more liquid discharge lines comprise two liquid discharge lines and the one or more seed lines comprise two seed lines and wherein a venturi inductor is located on each of two the liquid discharge lines at the connection to each of the two seed lines.

9. The convertible sprayer and seeder of claim 8, wherein the seeding valves are located on each of the two seed lines and are individually openable to allow flow of seeds into the respective liquid discharge line in a seeding operation mode, and individually closeable in a spraying-only operation mode.

10. The convertible sprayer and seeder of claim 9, further comprising two bypass lines, each including a bypass valve, each bypass valve being individually openable when seeding valves are closed to allow for spraying-only operation mode, and being individually closeable when seeding valves are opened to allow seeds to enter the venturi inductor in the seeding operation mode.

11. The convertible sprayer and seeder of claim 1, wherein the one or more liquid discharge lines comprise a single liquid discharge line having a single venturi inductor located thereon, and the one or more seed lines comprise a single seed line feeding into the venturi inductor.

12. The convertible sprayer and seeder of claim 11, comprising a first pump for pumping liquid from the liquids tank to the single venturi inductor and a second pump for pumping liquid from the liquids tank to a location downstream of the venturi, to supplement liquid supply to the nozzles of the wet boom.

13. The convertible sprayer and seeder of claim 12, wherein the second pump serves to increase draw of liquids to induct the seeds into the nozzles.

14. The convertible sprayer and seeder of claim 13, further comprising a check valve serves to prevent backflow of seeds or liquids into the venturi inductor 26 or further back upstream, when in a spraying-only operation mode.

15. A method of seeding a cover crop or relay crop, said method comprising the steps of:
a. providing the convertible sprayer and seeder of claim 1;
b. opening each of the seeding valves and closing each of the bypass mechanisms;
c. adjusting each nozzle opening to allow passage of seeds therethrough; and
d. as the convertible sprayer and seeder is driven across a field, metering seeds from the applicator through the seed lines and through the venturi into the liquid discharge lines and out through the nozzles.
